(19) United States
(12) Patent Application Publication
(10) Pub. No.: US 2012/0197666 A1
(43) Pub. Date: Aug. 2, 2012

(54) METHOD AND APPARATUS FOR PROVIDING UNEMPLOYMENT INSURANCE

(75) Inventors: Joan Patricia McDonald Meyer, Atlanta, GA (US); Alexa Stephens, Miami, FL (US); Alison P. Northup, New York, NY (US); Cassandra G. Conrad, Naples, FL (US); Michael James Yates, Alpharetta, GA (US)

(73) Assignee: Assurant, Inc.

(21) Appl. No.: 13/015,726

(22) Filed: Jan. 28, 2011

(51) Int. Cl. G06Q 40/00

(52) U.S. Cl. 705/4

(57) ABSTRACT

An apparatus for unemployment insurance may include a processor and a non-transitory memory storing instructions. The instructions, responsive to execution, configure the processor to cause the apparatus at least to perform receiving information indicative of a user selection of an unemployment insurance coverage option defining policy parameters corresponding to a policy entitling the user to receive a financial benefit for a predefined period of time in response to an occurrence of a qualifying involuntary unemployment event and determining a premium fee to be paid on behalf of the user to maintain the policy. The premium fee may be determined based at least in part on the user selected coverage option. The instructions may further configure the processor to cause the apparatus to perform determining an allocation for funds associated with the premium fee between a cost of insurance and a smart cash reserve, and, in response to receiving an indication of the occurrence of the qualifying involuntary unemployment event, causing provision of the financial benefit to user. The smart cash reserve may hold funds of the policy to cover initial payout on any claim against the policy until depletion of the smart cash reserve before payout is covered by insurance.

### BACKGROUND

Many people are ill prepared for loss of income due to unemployment even though they feel the risk of job loss is great. Evidence of this can be seen by the fact that savings rates are low compared to decades ago, state unemployment benefits cover only a fraction of living expenses, and most Americans do not believe they are prepared to cover even 3 months of living expenses in the event of job loss. Government and employer-sponsored unemployment protection safety nets are considered by many to be inadequate and diminishing. On average, state unemployment benefits replace only ⅓ of the average worker's earnings while higher earning workers experience must less satisfactory coverage. Just handling day-to-day expenses is proving tough for American households and thus, disruptive events such as car repairs, home repairs, tuition, medical bills, household appliance replacement, and/or the like may add to the debt of even fully employed, middle income households.

Among consumers, there is a trend toward more conservatism in spending and saving. Consumers are developing an awareness that they cannot rely on available credit to fuel purchases and balance their household budgets in the event of an income interruption. It has also been demonstrated that access to credit lines is not a guarantee as banks have cut trillions of dollars in available credit to consumers during the recent economic crisis. Accordingly, consumers have very few places to turn during times of income interruption due to unemployment.

Many consumers feel that they are likely to experience job loss at some point in their working lives and surveys show that between 50% and 66% of all Americans fear they will lose their job. Despite this fear, many consumers remain ill prepared for job loss. Personal savings rates have declined from over 12% in the 1970s to 0.4% in 2006. Additionally, many households have also recently experienced stagnant or declining incomes. Meanwhile, growth in the cost of living outpaces growth in income thereby putting many consumers in a position of relying on sources of debt (e.g., home equity loans and credit cards) at a heavy cost that further compounds the ability to be prepared for an income interruption.

While consumers see the value of saving, it generally takes a relatively long time to build up sufficient funds to cover unexpected unemployment events. Complicating matters further, the rate at which savings earn interest is relatively low, making the ability to earn interest and watch your nest egg grow, a long process. Aside from personal savings and government sponsored unemployment benefits, there is no solid solution providing substantial funds to consumers to solve their needs during unexpected times of unemployment. Debt deferment and debt cancellation programs exist, but these are generally tied to specific debts and cover only specific debt obligations such as credit card, auto loans and mortgages. There is no known operating individual unemployment insurance coverage available to protect the customer against income interruption while providing significant cash-benefits for the consumer to spend as they deem fit during times of unemployment.

The challenge to providing a suitable individual unemployment insurance coverage has been the result of adverse selection (a situation where demand for a product comes from those most likely to produce the outcomes insured against, resulting in claimants outweighing non-claimants and inability to produce a profitable product). At one point, a product was available that featured a stand-alone involuntary unemployment benefit. This product allowed the consumer to pay a monthly premium which would in turn pay out cash should the insured experience a qualified unemployment event. This stand-alone product configuration proved to not work, especially in a heightened unemployment rate environment. Losses were significantly higher than revenues. One may think that a simple modification to the pricing structure of the product could have made the program profitable. However, it would have been too costly for consumers and higher price points primarily attract those who know they have an unemployment event coming, creating significant adverse selection, and thereby rendering the product unprofitable.

Accordingly, it may be desirable to configure a product that can work, regardless of the unemployment environment.

### BRIEF SUMMARY OF VARIOUS EMBODIMENTS

In evaluating the purchase of an insurance policy, consumers generally weigh the cost of a short-term premium payment relative to the likelihood and magnitude of the risk of a specific event occurring. Products that can build in certainty of benefit payout (as occurs with certain life insurance products or insurance with return of premiums) may help reinforce that value exists in the product whether or not the fortuitous event occurs. Accordingly, some example embodiments of the present disclosure may provide a product that provides consumers with needed funds to meet short term obligations and immediate basic needs during hardships brought on by unemployment. The product offered is an insurance product for providing income replacement up to a certain amount in response to involuntary unemployment. Premiums are allocated to cover the cost of insurance and also to fund a cash value account that is owned by the policy.

In an example embodiment, a method for providing an unemployment insurance product is provided. The method may include receiving information indicative of a user selection of an unemployment insurance coverage option defining policy parameters corresponding to a policy entitling the user to receive a financial benefit for a predefined period of time in response to an occurrence of a qualifying involuntary unemployment event and determining a premium fee to be paid on behalf of the user to maintain the policy. The premium fee may be determined based at least in part on the user selected coverage option. The method may further include determining an allocation for funds associated with the premium fee between a cost of insurance and a smart cash reserve, and, in response to receiving an indication of the occurrence of the qualifying involuntary unemployment event, causing provision of the financial benefit to user. The smart cash reserve may hold funds of the policy to cover initial payout on any claim against the policy until depletion of the smart cash reserve before payout is covered by insurance.

In another example embodiment, apparatus for providing unemployment insurance is provided. The apparatus may include a processor and a non-transitory memory storing instructions. The instructions, responsive to execution, configure the processor to cause the apparatus at least to perform receiving information indicative of a user selection of an unemployment insurance coverage option defining policy parameters corresponding to a policy entitling the user to receive a financial benefit for a predefined period of time in response to an occurrence of a qualifying involuntary unemployment event and determining a premium fee to be paid on behalf of the user to maintain the policy. The premium fee may be determined based at least in part on the user selected coverage option. The instructions may further configure the processor to cause the apparatus to perform determining an allocation for funds associated with the premium fee between a cost of insurance and a smart cash reserve, and, in response to receiving an indication of the occurrence of the qualifying involuntary unemployment event, causing provision of the financial benefit to user. The smart cash reserve may hold funds of the policy to cover initial payout on any claim against the policy until depletion of the smart cash reserve before payout is covered by insurance.

In yet another example embodiment, a computer program product for providing an unemployment insurance product is provided. The computer program product may include at least one non-transitory computer-readable storage medium having computer-executable program code instructions stored therein. The computer-executable program code instructions may include program code instructions for receiving information indicative of a user selection of an unemployment insurance coverage option defining policy parameters corresponding to a policy entitling the user to receive a financial benefit for a predefined period of time in response to an occurrence of a qualifying involuntary unemployment event and determining a premium fee to be paid on behalf of the user to maintain the policy. The premium fee may be determined based at least in part on the user selected coverage option. The computer-executable program code instructions may further include program code instructions for determining an allocation for funds associated with the premium fee between a cost of insurance and a smart cash reserve, and, in response to receiving an indication of the occurrence of the qualifying involuntary unemployment event, causing provision of the financial benefit to user. The smart cash reserve may hold funds of the policy to cover initial payout on any claim against the policy until depletion of the smart cash reserve before payout is covered by insurance.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a Plan Implementation System according to an example embodiment;

FIG. 2 is a schematic diagram of a Plan Implementation Server according to one example embodiment;

FIG. 3 is a block diagram of a Plan Implementation System according to a further example embodiment;

FIG. 4 is a flow chart illustrating operations associated with the setup of an unemployment insurance plan according to an example embodiment;

FIG. 5 illustrates an example of a process for claims processing according to an example embodiment;

FIG. 6 illustrates an example architecture for an apparatus configured to perform functions associated with providing unemployment insurance according to an example embodiment; and

FIG. 7 is a flow chart illustrating a method for providing unemployment insurance according to an example embodiment.

### DETAILED DESCRIPTION OF VARIOUS EMBODIMENTS

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein. Rather, these embodiments are provided so that this disclosure will satisfy applicable legal requirements. Like numbers refer to like elements throughout.

### Brief Overview

Disclosed are various systems and methods for creating and implementing an unemployment insurance product that provides individuals with insurance coverage to replace income up to a certain amount in the event of involuntary unemployment. In some embodiments, the product provides a significant benefit up to a specified number of months. With this substantial coverage, consumers can feel less stressed, more in control and better able to make more considered decisions for themselves and their family when unemployment strikes.

Some example embodiments may require a policy/arrangement where the insurance company and the insured both take on certain risks associated with potential unemployment events. Algorithms and calculations based on unemployment data and other economic indicators, may allow for the product to be sustainable.

Some example embodiments may provide for a ramp up period that allows policy benefit levels to slowly grow up to the policy maximum benefit, which may mitigate the adverse selection issues of traditional models while providing potential for larger cash benefits for consumers. An example embodiment may also incorporate dynamic monthly adjustments to the cost of insurance rates charged to the consumer based on certain factors such as economic indicators and current unemployment data (e.g., unemployment rates and/or claim data), which may include geographic-based or national-based data. Example embodiments may employ fewer internal adjustments and multiplication of resulting factors by a net amount at risk to offer increased potential upside to consumers whereby they may be charged based on near real-time occurrences.

Some embodiments may also provide for the creation of a smart cash reserve feature of the policy that builds up over time. The smart cash reserve may serve as a normalization account to provide the consumer with the ability to partially self-insure against unemployment loss. This may lower the consumer's net amount at risk and also lower the cost of insurance charges. The smart cash reserve may also be paid out at policy termination, if the funds in the smart cash reserve are not otherwise used in claim situations. Monthly calculations and adjustments of the net amount at risk may be made based on the balance of the consumer's smart cash reserve to thereby reduce the cost of insurance charged to a consumer each month and in times of steady employment.

### System Architecture

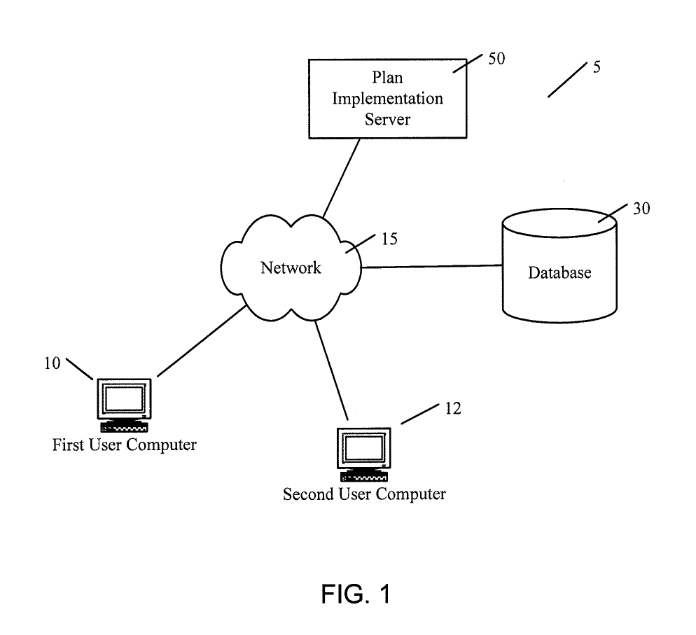

In various embodiments, a Plan Implementation Computer System 5 is used to implement the funding assurance plan. One embodiment of a suitable Plan Implementation Computer System 5 is shown in FIG. 1. As may be understood from this figure, in this embodiment, the system 5 includes one or more user computers 10, 12 that are connected, via a network 15 (e.g., a LAN or the Internet), to communicate with a Plan Implementation Server 50. The first user computer 10 and the second user computer 12 are merely shown to illustrate the potential for multiplicity in relation to the number of terminals that may interface with the Plan Implementation Server 50. Thus, some embodiments may employ only one of the first user computer 10 and the second user computer 12, while other embodiments may employ two or more such computers. In an example embodiment, the system 5 may be configured for retrieving data from and storing data to a database 30 that may be stored on (or, alternatively, stored remotely from) the Plan Implementation Server 50.

In an example embodiment, either or both of the first user computer 10 and the second user computer 12 may be a personal computer (PC) or a laptop computer associated with a particular individual or organization. For example, one or more computers may be associated with consumers and another one or more computers may be associated with an insurance company or financial institution. However, in other cases, either or both of the either or both of the first user computer 10 and the second user computer 12 may be a personal digital assistant (PDA), mobile telephone (or smart phone), or a client terminal associated with a financial institution, an insurance provider or other entity. As such, in some cases, the first user computer 10 or second user computer 12 may represent a terminal for providing user interface with the system 5. In some embodiments, middleware associated with a particular financial institution or insurance provider may be provided between the computers and the Plan Implementation Server 50 to enable the Plan Implementation Server 50 to interface with corresponding different input terminals. Moreover, in some embodiments, the Plan Implementation Server 50 may host a website accessible by the either or both of the first user computer 10 and the second user computer 12 to enable policy setup, policy modification and/or claims reporting.

It should be appreciated that FIG. 1 illustrates one example architecture for the Plan Implementation Computer System 5, and numerous other architectures could be equally applicable to various example embodiments. Thus, for example, some embodiments may include additional components, fewer components, or different components than those illustrated in FIG. 1. Generally speaking, the Plan Implementation Computer System 5 may be configured to enable prequalification of an individual, capture data to enroll the individual, trigger the setup of an insurance policy for the individual with corresponding premium payments being determined based at least in part on the information provided by the individual, and/or allocate funds from the premium according to the structure of the product to enable claims handling. Data associated with the insurance policy may then be stored to the database 30, and retrieved therefrom as needed to perform other functionalities described herein.

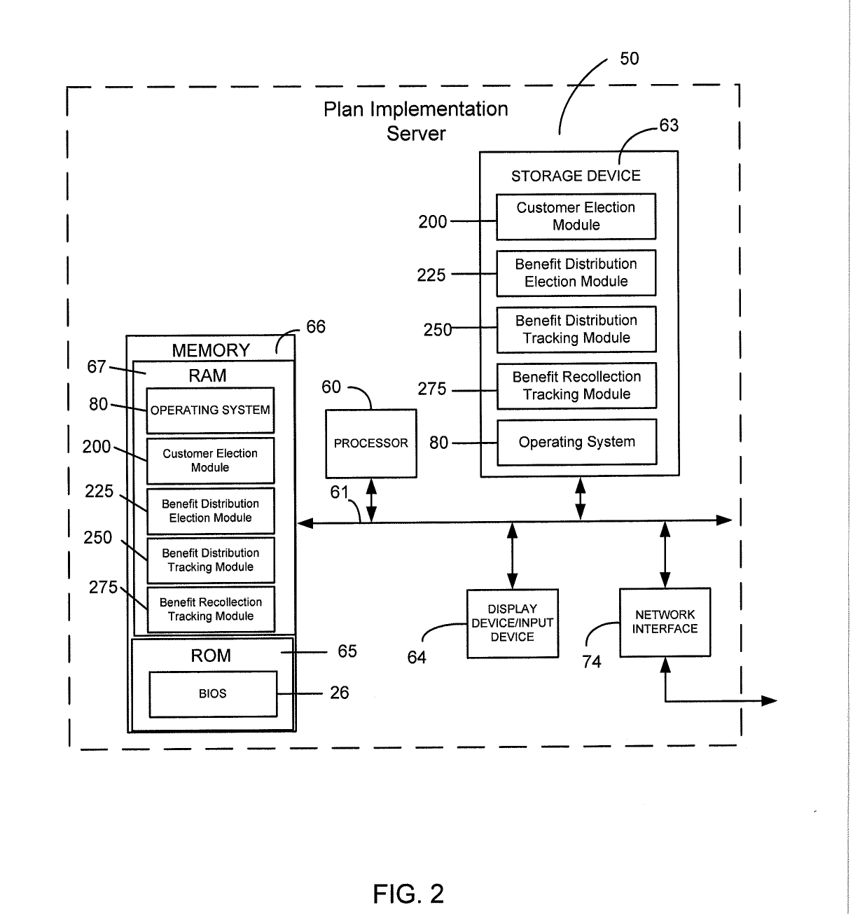

FIG. 2 shows a schematic diagram of the Plan Implementation Server 50 according to one embodiment of the invention. The Plan Implementation Server 50 includes a processor 60 that communicates with other elements within the Plan Implementation Server 50 via a system interface or bus 61. Also included in the Plan Implementation Server 50 is a display device/input device 64 for receiving and displaying data. This display device/input device 64 may be, for example, a keyboard or pointing device that is used in combination with a monitor. The Plan Implementation Server 50 further includes memory 66, which may include both read only memory (ROM) 65 and random access memory (RAM) 67. The server's ROM 65 may be used to store a basic input/output system 26 (BIOS), containing the basic routines that help to transfer information between elements within the Plan Implementation Server 50.

In addition, the Plan Implementation Server 50 includes at least one storage device 63, such as a hard disk drive, a floppy disk drive, a CD Rom drive, or optical disk drive, for storing information on various non-transitory computer-readable media, such as a hard disk, a removable magnetic disk, or a CD-ROM disk. As will be appreciated by one of ordinary skill in the art, each of these storage devices 63 may be connected to the system bus 61 by an appropriate interface. The storage devices 63 and their associated computer-readable media provide nonvolatile storage for a personal computer. It is important to note that the computer-readable media described above could be replaced by any other type of non-transitory computer-readable media known in the art. Such media include, for example, magnetic cassettes, flash memory cards, digital video disks, and Bernoulli cartridges.

A number of program modules may be stored by the various storage devices and within RAM 67. Such program modules include an operating system 80, a Customer Election Module 200, a Benefit Distribution Election Module 225, a Benefit Distribution Tracking Module 250, and a Benefit Recollection Tracking Module 275. The Customer Election Module 200, the Benefit Distribution Election Module 225, the Benefit Distribution Tracking Module 250, and the Benefit Recollection Tracking Module 275 may control certain aspects of the operation of the Plan Implementation Server 50, as is described in more detail below, with the assistance of the processor 60 and the operating system 80.

Also located within the Plan Implementation Server 50 is a network interface 74, for interfacing and communicating with other elements of a computer network. It will be appreciated by one of ordinary skill in the art that one or more of the Plan Implementation Server 50 components may be located geographically remotely from other Plan Implementation Server 50 components. Furthermore, one or more of the components may be combined, and additional components performing functions described herein may be included in the Plan Implementation Server 50.

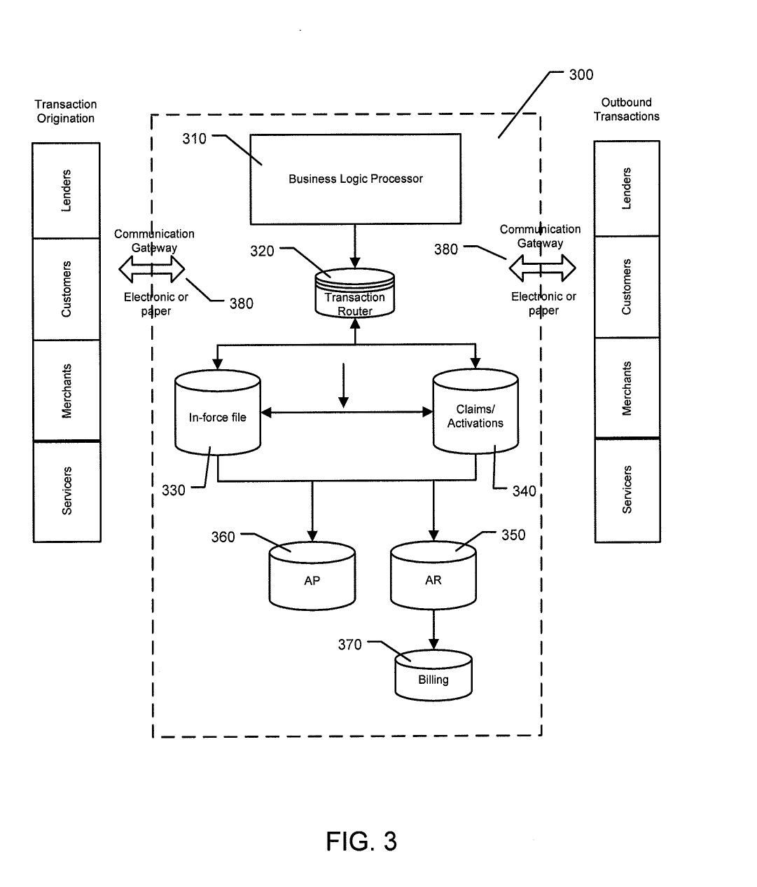

Another embodiment of a plan implementation system is shown in FIG. 3. In this embodiment, the Plan Implementation System 300 includes a Business Logic Processor 310 that is adapted for receiving and processing transaction information, and for passing the information to a Transaction Router 320, which routes information regarding the transaction to various other components of the system 300 for processing. The system 300 further includes an In-Force File 330, which may be, for example, a database or file that stores a listing of plans/policies that are currently in force. The system 300 further includes a Claims/Activations Server 340 that is configured for processing activations of new plans/policies, and for processing claims filed under those policies.

In some example embodiments, the system 300 also includes an Accounts Receivable Server 350 and a Billing Server 370, which are configured, respectively, to handle accounts receivable information and to process bills. In addition, the system 300 includes an Accounts Payable Server 360 for handling accounts payable.

In some example embodiments, the system 300 also includes a communication gateway 380 that may be configured to facilitate communications between the system 300 and, for example, servicers, merchants, customers, and lenders. The communication gateway 380 may, for example, be configured to handle the following types of inbound transactions and information: (1) new enrollments; (2) information regarding new insureds; (3) customer loan information; (4) customer instructions on cash disbursements; (5) billing transactions; and (6) debt history information. The communication gateway 380 may, for example, be configured to handle the following types of outbound transactions and information: (1) fulfillment package information; (2) requests for benefit communications; (3) payments; (4) billing; and (5) customer service communications.

### More Detailed Discussion of Various Embodiments

Various embodiments of the invention are described in greater detail below. The embodiments hereafter are merely non-limiting examples and generally relate to such topics as insurance policy set up and claims processing. Insurance policy set up may include setup of an unemployment insurance policy to provide a financial benefit to the consumer in the event of an involuntary job loss. Claims may be reported either online or via telephone and may be processed to adjudicate claims and distribute funds in accordance with the terms of the policy for valid claims.

### Insurance Policy Setup

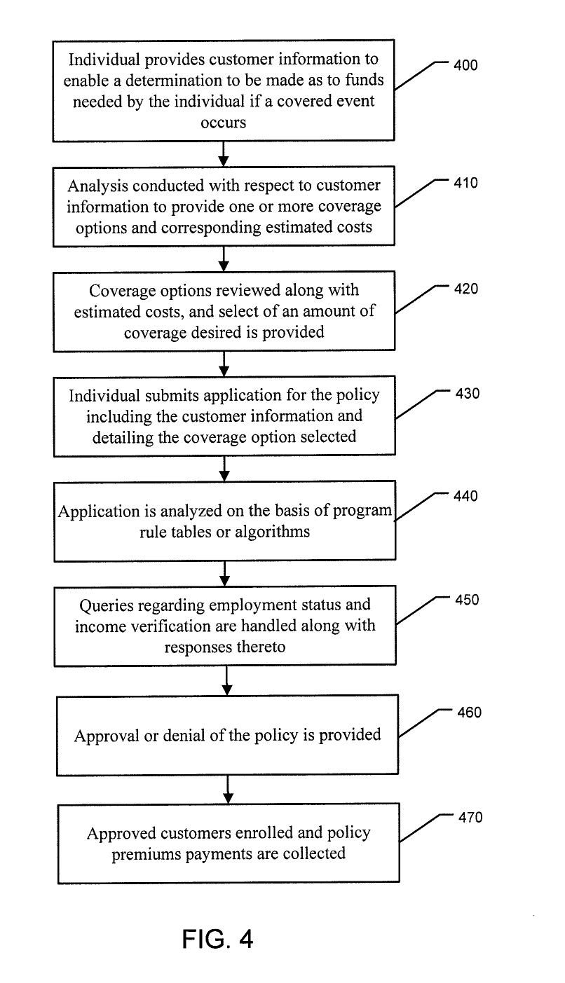

In an example embodiment, an individual may pay a premium fee (e.g. monthly premium charge) for an insurance policy in which an insurance company agrees to provide payments to the individual in the event that the individual experiences a qualified unemployment event. The premium fee will be divided with a portion being assigned to a smart cash reserve and another portion being assigned to cover the cost of insurance and any management fees that are applicable. A process for establishing the insurance policy is shown in the example flowchart of FIG. 4.

FIG. 4 illustrates the process of enrolling consumers into an insurance policy of an example embodiment. An individual (e.g., a consumer, applicant or customer) may desire to acquire protection against income loss in the event of an involuntary unemployment event or other covered event. As shown in FIG. 4, the individual may provide customer information to enable a determination to be made (e.g., by the Plan Implementation Server 50) as to the funds needed by the individual if a covered event occurs at operation 400. In some embodiments, the minimum required customer information may include income data for the individual. However, in some embodiments, any or all of other information relating to debt, ongoing financial obligations (e.g., routine monthly payments), savings, investments, and/or the like, may be used to determine the needed funds.

At operation 410, analysis may be conducted with respect to the customer information in order to provide the individual with one or more coverage options and corresponding estimated costs. In some embodiments, the individual may also be provided with data indicating an estimated amount of funds necessary to fill an income interruption gap for the individual. Various coverage options (e.g., at different percentages of the estimated amount of funds necessary) may then be provided with corresponding estimates as to the cost of each respective policy. In some cases, coverage ranges for which the individual may qualify may be identified as well along with other pertinent benefit details. The information may be presented to the individual via a graphic display (e.g., on the computer of the individual). In some embodiments, the salary of the individual may dictate or at least play a determining role to a certain degree with respect to the amount of coverage for which the individual qualifies.

The individual may review the coverage options provided along with the estimated costs and select an amount of coverage desired based on the information provided at operation 420. The individual may then submit an application for the policy including the customer information and detailing the coverage option selected at operation 430. The submission of the application may include electronic authorization for the insurance provider to verify the employment status and income of the individual as part of the underwriting process.

The application (e.g., including the customer data and coverage option selected) may then be analyzed on the basis of program rule tables and/or algorithms at operation 440. If required, queries regarding employment status and income verification may be handled electronically along with the responses thereto at operation 450. In some cases, where electronic queries and responses cannot be performed, manual verification may be conducted and the results may be entered. An approval or denial of the policy may be provided at operation 460 and the individual may be informed accordingly (e.g., via email notification, or response message via a graphical display). At operation 470, approved customers may be enrolled and may begin paying policy premiums for coverage.

In an example embodiment, as indicated above, the premium fee that is associated with any particular coverage option selected by the user is determined in contemplation of splitting the premium fee between a smart cash reserve and covering the cost of insurance. Determination of the premium fee may be accomplished in contemplation of the net amount at risk. Each individual may have his or her corresponding net amount at risk calculated and a cost of insurance factor may be applied to the net amount at risk to determine the portion of the premium fee that is to be allocated to the cost of insurance. The remainder of the premium fee may then be allocated to the smart cash reserve, which is owned by the policy and not by the individual. The net amount of risk is determined to be the total available funds in the policy's smart cash reserve less the total benefit available.

The premium fee may be fixed based on the customer selected coverage option (e.g., defining a benefit level and a corresponding premium fee). The premium fee may be paid by the individual and received by the insurance provider or an authorized agent thereof. A portion of the paid premium fee is allocated to cover the cost of insurance and the remaining portion is allocated to the smart cash reserve of the policy. In some embodiments, the premium fee may also cover administrative fees, profits, expenses, commissions, etc.

In some embodiments, the cost of insurance may be determined on a monthly basis since the cost of insurance will depend, at least in part, on various local and national factors. The cost of insurance may, in some example situations, have a predetermined maximum value (e.g., a “not to exceed” value). As such, in some cases the allocation of the premium fee between cost of insurance and smart cash reserve may be limited by a predetermined maximum. For example, the cost of insurance may be limited to the amount of the premium fee or some other value based on the amount of the premium fee less management expense fees. In some cases, the management and expense fees associated with maintaining the policy may be added to or included in the cost of insurance. In an example embodiment, published national or state economic indicators may be used in determining the cost of insurance for a particular individual (e.g., based on the local conditions where the individual is resident). Information such as current job loss rates, unemployment initial claims (e.g., from the U.S. Department of Labor) and/or other available and relevant unemployment related statistics may also be used in determining the cost of insurance. Demographic information indicating differences in national insured pool versus the insured pool of the insurance provider may also be considered along with internal factors that may be used to adjust data. Based on all available data (e.g., including national and local unemployment rates, claim rates or other related data), an expected loss ratio may be determined.

In an example cost of insurance calculation, the net amount of risk may be multiplied by the cost of insurance (e.g., an average national unemployment insurance claim rate over the most recent four available weeks) and factors for adjustment of risk and cost of insurance (e.g., differences in national insured pool versus the insured pool of the insurance provider). The result of the above described multiplication may be divided by the expected loss ratio and then management and expense fees may be subtracted to determine the overall cost of insurance value. The cost of insurance value may be deducted from the premium fee and the remaining portion may be allocated to the smart cash reserve of the policy. In situations where the cost of insurance happens to be higher than the premium fee, the deficiency may be deducted from the smart cash reserve.

In an example embodiment, the smart cash reserve may be an interest bearing account. Thus, for example, the smart cash reserve may have a predetermined interest rate applied to the funds therein. Since interest may be applied to the smart cash reserve, there may be situations in which interest bonuses may be paid depending on the duration of the policy and excess interest rates.

In some cases, the individual associated with the policy may elect to make a withdrawal from the smart cash reserve. In this regard, for example, the individual may elect to take out a loan against the smart cash reserve. However, in other examples, the amount withdrawn may not necessarily need to be repaid. The amount of the smart cash reserve that may be withdrawn (e.g., permanently or as a loan) at any given time may be subject to limitation (e.g., a maximum of 50% of the total balance). The individual may request the withdrawal either by phone or via an online or in-person request. In response to receiving a request for a withdrawal, a determination may be made (e.g., at the Plan Implementation Server 50) as to what withdrawal amount is available (e.g., based on any limitations that apply) and documentation may be provided to the individual as appropriate to enable the individual to receive the withdrawal. The individual may then provide disbursement instructions (e.g., identifying whether electronic distribution or check is preferred) to direct fund disbursement and the withdrawal may be funded and disbursed accordingly. After funds are disbursed, the total eligible benefit amounts associated with the policy may be adjusted based on the outstanding withdrawal amount. Thus, for example, the benefit amounts may be reduced corresponding to the amount withdrawn. If the amount withdrawn is not to be repaid, the terms of policy may be adjusted to indicate the corresponding term changes with respect to the benefits to be provided under the policy. Modified terms may apply for the remainder of the life of the policy or until the amount withdrawn (e.g., the loan amount) has been repaid. Thus, various example embodiments allow for operation in cases where the amount withdrawn is to be repaid (e.g., the loan amount), by providing that the individual may thereafter repay the loan according to the terms of the loan agreement and the smart cash reserve balance may be adjusted accordingly. Meanwhile, other example embodiments provide for operation in situations in which the individual decides not to repay the withdrawal amount. In these example cases, the terms and benefits of the policy may be reduced by the outstanding withdrawal amount and/or any indebtedness created by the withdrawal.

In some embodiments, a withdrawal schedule may be defined to indicate fees and/or penalties associated with the timing of making withdrawals. For example, in some cases the withdrawal schedule may provide for certain penalties or fee amounts that must be paid based on when, in the context of the life of the policy, a request for withdrawal is received. In some cases, penalties and/or fees may be higher for early withdrawal (e.g., withdrawals made during the first few months or years of the life of the policy) and may reduce over time. In some examples, the withdrawal schedule may define a policy age at which no withdrawal penalties are applicable. The withdrawal schedule may also define fees or charges that are applicable in cases where the policy is canceled and the individual would otherwise be entitled to receive a payout on the balance of the smart cash reserve.

Generally speaking, when the individual is eligible to receive benefits and a qualified involuntary unemployment event occurs, the individual may be eligible to receive a cash benefit under the terms of the policy. Lifetime maximums may be set as to the amounts that may be collected under the policy. Benefit amounts may be commensurate with the salary of the individual (i.e., the policy holder), with a percentage of the salary of the individual, or may be based on some other arrangement (e.g., a fixed amount). Benefit levels may be based on premium fees paid, the duration for which the policy is in force, the number of claims made and any loans for which the individual has depleted the smart cash reserve. In some embodiments, benefit levels may ramp up over time (e.g., based on an expected increase in the smart cash reserve) to policy maximum values.

As an example of the ramp up process, the individual may make premium payments for the insurance policy for a period of six months. If a qualified involuntary unemployment event occurs, the individual may be eligible for a benefit of $3000 over a period of six months. Meanwhile, if the individual makes premium payments for two years, they may be eligible to receive $6000 over the period of six months. If premium payments are made over 3 years, 4 years or 5 years, they may be eligible to receive $9000, $12,000 or $15,000, respectively, over the period of six months.

Claims Processing

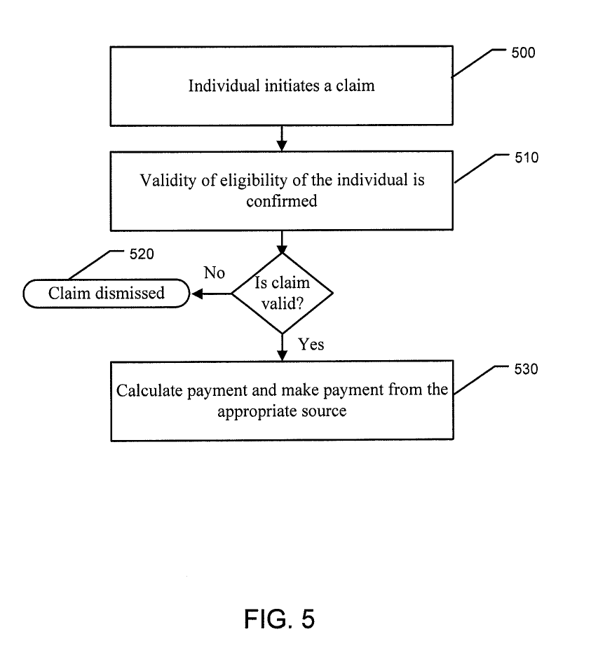

In an example embodiment, the individual may initiate a claim in response to the occurrence of a covered event. FIG. 5 illustrates an example of a process for claims processing according to an example embodiment. As shown in FIG. 5, the individual may initiate a claim at operation 500 by calling a claims hotline or other claims intake number associated with an insurance company providing the insurance policy. At operation 510, the validity of eligibility of the individual may be confirmed. At operation 520, if the claim is invalid, it may be dismissed. However, if the claim is valid, it may be passed on for further processing. At operation 530, a payment amount may be calculated and a payment may be provided from the appropriate source. The payment amount will generally be the coverage amount that corresponds to the premium fee paid by the individual. In an example embodiment, the source that funds the payment will be the smart cash reserve until no further funds are available therein. After the smart cash reserve is depleted to provide payment for a claim, the insurance portion of the policy steps in to cover the rest. Accordingly, the system may initially determine the appropriate source for paying each claim based on the status of the smart cash reserve of the policy.

As an example of a claim payment scenario, the individual may make payments corresponding to the premium fee for an insurance policy for 61 months and then experience a qualified involuntary unemployment event. Due to the extended period over which the policy has been maintained and the premium paid, the individual may be eligible to receive up to $30,000 in benefits at a rate of $5000 per month for up to 6 months, providing they remain unemployed over that period. If it is assumed for this example that the individual's policy has a smart cash reserve balance of $7,786, the first month's benefit of $5000 would be entirely covered by the smart cash reserve. In the second month, the remainder of the smart cash reserve would be withdrawn (i.e., $2786) and the insurance company would be expected to pay the remaining amount for the second month (i.e., $2214) and each other month (i.e., up to $20,000 over the four remaining months).

As another example, the individual may make payments corresponding to the premium fee for an insurance policy for 36 months and then experience a qualified involuntary unemployment event. Based on the period over which the policy has been maintained and the premium paid, the individual may be eligible to receive up to $9,000 in benefits at a rate of $1500 per month for up to 6 months, providing they remain unemployed over that period. If it is assumed for this example that the individual's policy has a smart cash reserve balance of $3500, the first month's benefit of $1500 and the second month's benefit of $1500 would be entirely covered by the smart cash reserve. In the third month, the remainder of the smart cash reserve would be withdrawn (i.e., $500) and the insurance company would be expected to pay the remaining amount for the third month (i.e., $1000) and each other month (i.e., up to $4500 over the three remaining months).

If no claim is made, or the individual does not use the full maximum benefit under the policy, the individual may be entitled to receive cash back at policy termination, less any surrender fees or indebtedness (e.g., if a loan was not paid back). As an example, if the individual makes payments corresponding to the premium fee for an insurance policy for 61 months and the policy has a smart cash reserve balance of $7,786 and never has a claim, the individual may be eligible to receive the full $7,786 in response to termination of the policy. As another example, if the individual makes premium fee payments for 36 months and the policy has a smart cash reserve balance of $3500, but there is a surrender fee of 50% for the policy, then the individual may only be entitled to $1750 in response to termination of the policy. As yet another example, if the individual makes payments corresponding to the premium fee for an insurance policy for 61 months and the policy has a smart cash reserve balance of $7,786, but the individual has taken out a loan against the smart cash reserve of $2000 and only repaid $500, then the individual may be eligible to receive the full $6,286 in response to termination of the policy.

It should be understood that various portions (if not all) of the operations described above (and other operations described herein) may be performed, for example, via the Plan Implementation System 300 or the Plan Implementation Server 50. It should be further understood that particular example embodiments of the invention may include a combination of any one or all of the embodiments described above, or various other embodiments.

### Exemplary Software Modules

In particular embodiments, the functionality described above is executed by a computer system running the various exemplary software modules described below. Some of the exemplary software modules may provide functionality for displaying information to the user on a graphical display and perhaps also receiving input from the user relative to displayed information (e.g., via a dashboard or other on-line interface). Other modules may provide for processing, policy modification and/or the like as described herein. It should be understood that these modules are exemplary, and that other types of software modules could be used in alternative embodiments. Moreover, these modules may correspond to, be in addition to, or be portions of the modules described above in connection with FIG. 2. The functionality of each respective module may be caused via execution of instructions (corresponding to each respective functionality) that are stored in a non-transitory medium (e.g., memory 66) by a processing device (e.g., processor 60).

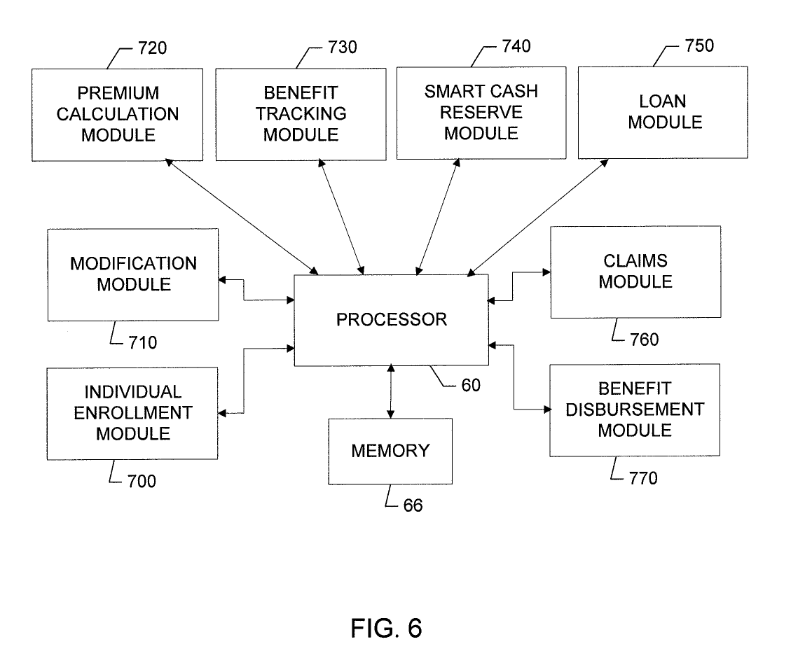

Individual Enrollment Module: In an example embodiment, the individual enrollment module (e.g., element 700 in FIG. 6) may be configured to present individuals with options to: (1) assess their needs in relation to the program (e.g., how much unemployment insurance coverage they will require based upon their current monthly income and perhaps also their current monthly bills and/or costs); (2) select the appropriate coverage selections to meet those needs (e.g., in relation to term and coverage amount); and (3) receive an estimate for the premium fee that would be due for a respective amount of coverage (i.e. providing an outline or example of expected premium charges on a monthly basis, based on the level of coverage selected).

Modifications Module: In an example embodiment, the individual (e.g., policyholder) may be enabled to access a web page or other user interface to modify the policy under certain conditions. For example, if the individual wishes to assign or re-assign beneficiaries or request policy changes to reflect corresponding changes in the unemployment benefit needs of the individual, the modifications module (e.g., element 710 in FIG. 6) may be used to grant the user access to make such changes.

Premium Calculation Module: In an example embodiment, the premium calculation module (e.g., element 720 in FIG. 6) may be configured to receive detailed information on the selected level of coverage of the individual and utilize rules, tables or algorithms that incorporate other information (e.g., local and/or federal unemployment data or other economic indicators) to determine an appropriate premium fee to charge the user for the selected level of coverage.

Benefit Tracking Module: In some example embodiments, the benefit tracking module (e.g., element 730 in FIG. 6) may be configured to track the benefit distribution expected to be paid to the individual over a predefined period of time (e.g., a maximum of 6 (six) months) in the event of the occurrence of a qualifying involuntary unemployment event. In various embodiments, the benefit tracking module may be configured to enable the individual to receive a real-time display (e.g., via a dashboard display) of their current benefit eligibility in terms of amount and period over which such benefits may be paid. In cases where an individual is not yet eligible (e.g., due to being in a waiting period prior to the benefit being available), the individual may be shown the projected date that eligibility is expected to be achieved and the corresponding expected benefit when eligibility is reached.

Smart cash reserve Module: In an example embodiment, the smart cash reserve module (e.g., element 740 in FIG. 6) may be configured to enable the individual to receive information indicative of the current amount of funds contributed (and interest accumulated, if applicable) to the smart cash reserve of the individual's policy. Thus, the individual may be made aware of the amount of funds that are available in case the individual would like to take out a loan against the smart cash reserve.

Loan Module: Some example embodiments may provide the individual with the ability to apply for a loan against the smart cash reserve using a loan module 750. The loan module may also enable the individual to monitor the status of any outstanding loans (e.g., showing the payments due, remaining balance, payment schedule, etc.). The loan module may also provide the individual with a mechanism for making loan payments.

Claims Module: In an example embodiment, a claims module 760 may be provided to enable the individual to make claims on-line or guide the individual through the process of making claims by other methods (e.g., either in writing or by phone). The claims module may also provide the individual with a mechanism by which to track the status of a claim being processed after the claim is submitted.

Benefit Disbursement Module: In some example embodiments, a benefit disbursement module 770 may be provided to enable the individual to direct benefit payments for distribution.

### Exemplary Hardware

FIG. 6 illustrates an example architecture for an apparatus configured to perform the functions described above. Thus, in an example embodiment, the exemplary modules described above may be embodied via instructions stored in one or more non-transitory storage mediums (e.g., memory 66) for execution via one or more processors (e.g., processor 60). The processor 60 may be embodied in a number of different ways. For example, the processor 60 may be embodied as one or more of various hardware processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 60 may be configured to execute instructions stored in the memory 66 or otherwise accessible to the processor 60. By executing stored instructions or operating in accordance with hard coded instructions, the processor 60 may control the operation of the modules described herein by directing functionality of the corresponding modules (700 to 770) associated with implementing product setup and administration as described above according to the respective configuration provided to the corresponding modules by the processor 60 and/or the instructions stored in memory for configuring the processor 60. As such, whether configured by hardware or software methods, or by a combination thereof, the processor 60 may represent an entity capable of performing operations according to embodiments of the present invention while configured accordingly. Moreover, the configuration of the processor 60 to perform the corresponding operations described herein thereby specifically configures the processor 60 to function as a particular machine designed to perform the corresponding operations.

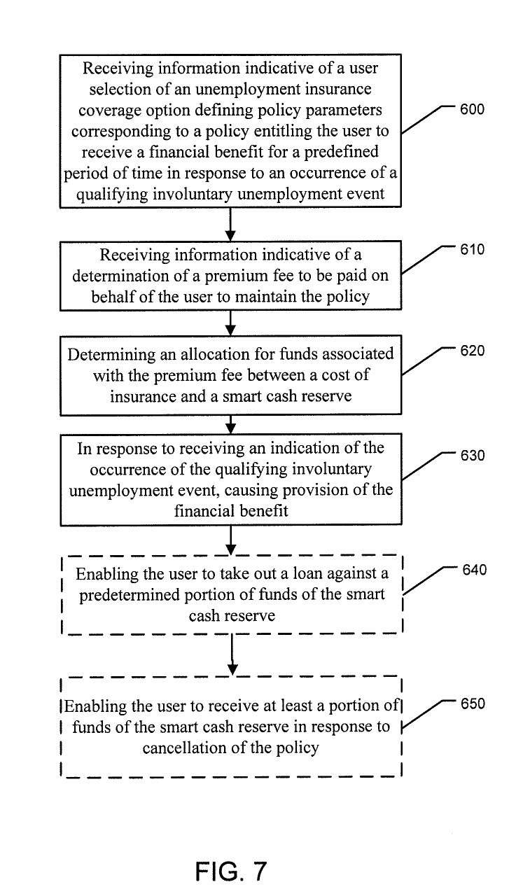

FIG. 7 is a flowchart of a system, method and program product according to some example embodiments. It will be understood that each block or operation of the flowchart, and combinations of blocks in the flowchart, can be implemented by various means, such as hardware, firmware, and/or software including one or more computer program instructions. For example, one or more of the procedures described above may be embodied by computer program instructions. In this regard, in an example embodiment, the computer program instructions which embody the procedures described above are stored by a memory device and executed by a processor or controller. As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or operation(s). In some embodiments, the computer program instructions are stored in a non-transitory computer-readable memory that can direct a computer or other programmable apparatus to function in a particular manner, such that the instructions stored in the computer-readable memory produce an article of manufacture including instruction means which implement the function specified in the flowchart block(s) or operation(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide steps for implementing the functions specified in the flowchart block(s) or operation(s).

Accordingly, blocks or operations of the flowchart support combinations of means for performing the specified functions, combinations of operations for performing the specified functions and program instruction means for performing the specified functions. It will also be understood that one or more blocks or operations of the flowchart, and combinations of blocks or operations in the flowchart, can be implemented by special purpose hardware-based computer systems which perform the specified functions or operations, or combinations of special purpose hardware and computer instructions.

One example of a method for providing an insurance product of an example embodiment as provided in FIG. 7 may include receiving information indicative of a user selection of an unemployment insurance coverage option defining policy parameters corresponding to a policy entitling the user to receive a financial benefit for a predefined period of time in response to an occurrence of a qualifying involuntary unemployment event at operation 600 and receiving information indicative of a determination of a premium fee to be paid on behalf of the user to maintain the policy at operation 610. The premium fee may be determined based at least in part on the user selected coverage option. The method may further include determining an allocation for funds associated with the premium fee between a cost of insurance and a smart cash reserve at operation 620, and, in response to receiving an indication of the occurrence of the qualifying involuntary unemployment event, causing provision of the financial benefit to user at operation 630. The smart cash reserve may hold funds of the policy to cover initial payout on any claim against the policy until depletion of the smart cash reserve before payout is covered by insurance.

In some embodiments, certain ones of the operations above may be modified or further amplified as described below. Moreover, in some cases, embodiments may include additional operations (some examples of which are shown in dashed lines in FIG. 6). It should be appreciated that each of the modifications, additions or amplifications below may be included with the operations above either alone or in combination with any others among the features described herein. In an example embodiment, the method may further include enabling the user to make a withdrawal (e.g., as a loan or permanently) against a predetermined portion of funds of the smart cash reserve at operation 640. In some embodiments, the method may further include enabling the user to receive at least a portion of funds of the smart cash reserve in response to cancellation of the policy at operation 650. In connection with either or both of operations 640 and 650, there may be fees or charges applied in accordance with a withdrawal schedule. In some embodiments, determining the premium fee may include determining a fixed premium amount and wherein determining the allocation comprises determining a variable allocation that is adjusted each month. In an example embodiment, determining the allocation may include utilizing market indicators, national unemployment data or local unemployment data for a region of the user to adjust the cost of insurance on a periodic basis and adjusting the allocation accordingly. In some embodiments, determining the allocation may include utilizing existing funds in the smart cash reserve to fund the premium fee in response to the cost of insurance being higher than the premium fee for a period of time.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

I claim:

1. A method comprising:
receiving information indicative of a user selection of an unemployment insurance coverage option defining policy parameters corresponding to a policy entitling the user to receive a financial benefit for a predefined period of time in response to an occurrence of a qualifying involuntary unemployment event;
receiving information indicative of a determination of a premium fee to be paid on behalf of the user to maintain the policy, the premium fee being determined based at least in part on the user selected coverage option;
determining, via a processor, an allocation for funds associated with the premium fee between a cost of insurance and a smart cash reserve, the smart cash reserve holding funds of the policy to cover initial payout on any claim against the policy until depletion of the smart cash reserve before payout is covered by insurance; and
in response to receiving an indication of the occurrence of the qualifying involuntary unemployment event, causing provision of the financial benefit to user.

2. The method of claim 1, wherein determining the allocation comprises utilizing market indicators to adjust the cost of insurance on a periodic basis and adjusting the allocation accordingly.

3. The method of claim 1, wherein determining the allocation comprises utilizing national unemployment data to adjust the cost of insurance on a periodic basis and adjusting the allocation accordingly.

4. The method of claim 1, wherein determining the allocation comprises utilizing local unemployment data for a region of the user to adjust the cost of insurance on a periodic basis and adjusting the allocation accordingly.

5. The method of claim 1, wherein determining the allocation comprises utilizing existing funds in the smart cash reserve to fund the premium fee in response to the cost of insurance being higher than the premium fee for a period of time.

6. The method of claim 1, wherein the cost of insurance is capped at a value determined based on the premium fee.

7. The method of claim 1, wherein the cost of insurance is capped at a value based on the premium fee adjusted by management expense fees.

8. The method of claim 1, further comprising enabling the user to make a withdrawal against a predetermined portion of funds of the smart cash reserve.

9. The method of claim 1, further comprising enabling the user to receive at least a portion of funds of the smart cash reserve in response to cancellation of the policy.

10. The method of claim 1, wherein determining the premium fee comprises determining a fixed premium amount and wherein determining the allocation comprises determining a variable allocation that is adjusted each month.

11. An apparatus comprising a processor and non-transitory memory storing instructions, the instructions, responsive to execution, configuring the processor to cause the apparatus at least to perform:
receiving information indicative of a user selection of an unemployment insurance coverage option defining policy parameters corresponding to a policy entitling the user to receive a financial benefit for a predefined period of time in response to an occurrence of a qualifying involuntary unemployment event;
receiving information indicative of a determination of a premium fee to be paid on behalf of the user to maintain the policy, the premium fee being determined based at least in part on the user selected coverage option;
determining an allocation for funds associated with the premium fee between a cost of insurance and a smart cash reserve, the smart cash reserve holding funds of the policy to cover initial payout on any claim against the policy until depletion of the smart cash reserve before payout is covered by insurance; and
in response to receiving an indication of the occurrence of the qualifying involuntary unemployment event, causing provision of the financial benefit to user.

12. The apparatus of claim 11, wherein the instructions configure the processor to cause the apparatus to determine the allocation by utilizing market indicators to adjust the cost of insurance on a periodic basis and adjusting the allocation accordingly.

13. The apparatus of claim 11, wherein the instructions configure the processor to cause the apparatus to determine the allocation by utilizing national unemployment data or by utilizing local unemployment data for a region of the user to adjust the cost of insurance on a periodic basis and adjusting the allocation accordingly.

14. The apparatus of claim 11, wherein the instructions configure the processor to cause the apparatus to determine the allocation by utilizing existing funds in the smart cash reserve to fund the premium fee in response to the cost of insurance being higher than the premium fee for a period of time.

15. The apparatus of claim 11, wherein the instructions further configure the processor to cause the apparatus to perform enabling the user to make a withdrawal against a predetermined portion of funds of the smart cash reserve or enabling the user to receive at least a portion of funds of the smart cash reserve in response to cancellation of the policy.

16. The apparatus of claim 11, wherein the cost of insurance is capped at a value determined based at least in part on the premium fee.

17. The apparatus of claim 11, wherein the instructions configure the processor to cause the apparatus to determine the premium fee by determining a fixed premium amount and wherein the instructions configure the processor to cause the apparatus to determine the allocation by determining a variable allocation that is adjusted each month.

18. A computer program product comprising at least one non-transitory computer-readable storage medium having computer-executable program code instructions stored therein, the computer-executable program code instructions comprising program code instructions for:
receiving information indicative of a user selection of an unemployment insurance coverage option defining policy parameters corresponding to a policy entitling the user to receive a financial benefit for a predefined period of time in response to an occurrence of a qualifying involuntary unemployment event;
receiving information indicative of a determination of a premium fee to be paid on behalf of the user to maintain the policy, the premium fee being determined based at least in part on the user selected coverage option;
determining an allocation for funds associated with the premium fee between a cost of insurance and a smart cash reserve, the smart cash reserve holding funds of the policy to cover initial payout on any claim against the policy until depletion of the smart cash reserve before payout is covered by insurance; and
in response to receiving an indication of the occurrence of the qualifying involuntary unemployment event, causing provision of the financial benefit to user.

19. The computer program product of claim 18, wherein program code instructions for determining the allocation include instructions for utilizing market indicators, national unemployment data or local unemployment data for a region of the user to adjust the cost of insurance on a periodic basis and adjusting the allocation accordingly.

20. The computer program product of claim 18, wherein program code instructions for determining the allocation include instructions for utilizing existing funds in the smart cash reserve to fund the premium fee in response to the cost of insurance being higher than the premium fee for a period of time.

21. The computer program product of claim 18, wherein program code instructions for determining the premium fee include instructions for determining a fixed premium amount and wherein program code instructions for determining the allocation include instructions for determining a variable allocation that is adjusted each month.
